(19) United States
(12) Patent Application Publication
(10) Pub. No.: US 2009/0046459 A1
(43) Pub. Date: Feb. 19, 2009

(54) LIGHTING DEVICE

(75) Inventors: Willem Lubertus Ijzerman, Eindhoven (NL); Ramon Pascal Van Gorkom, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/093,718

(22) PCT Filed: Nov. 9, 2006
(86) PCT No.: PCT/IB2006/054176

§ 371 Date: May 15, 2008

(30) Foreign Application Priority Data
Nov. 21, 2005 (EP) 05110992.4

(51) Int. Cl. F21V 7/22

(52) U.S. Cl. 362/240

(57) ABSTRACT

The present invention relates to a lighting system comprising a plurality of LEDs emitting light with different colors. The LEDs are provided with collimating optical components (51, 55) in order to emit collimated light beams. The LEDs are arranged in at least two layers (43, 45) and the collimating optical components (51) in the front layer are dichroic reflectors, so that they reflect the light from the associated front layer LED but transmit the light emitted from the rear layer behind. This eliminates or reduces the occurrence of colored edges around shadows on an illuminated surface.

The present invention relates to a lighting device comprising a plurality of light emitting diodes, each diode having a collimating optical component, and being arranged to emit light in a lighting direction.

Such a device is disclosed e.g. in U.S. Pat. No. 6,554,451. By using light emitting diodes (LEDs) with different colors, such a device can controllably illuminate a surface with light having virtually any color, including white light.

A problem with such a system however is the occurrence of undesired colored shadow edges where an obstacle interrupts the light path.

An object of the present invention is therefore to provide a device of the kind mentioned in the opening paragraph in which colored shadow edges are eliminated or at least reduced.

This object is achieved by means as defined in claim 1.

More specifically, the invention then comprises a lighting device having a plurality of light emitting diodes, each diode having a collimating optical component, and being arranged to emit light in a lighting direction, wherein a first subset of the diodes is placed in a front layer, a second subset of the diodes is placed in a rear layer, the front layer being placed in front of the rear layer as seen in the lighting direction, and the collimating optical components of the diodes in the front layer comprise dichroic reflectors.

Thanks to this arrangement, in which a first LED comprising a collimating optical element emits light and a second optical element can be placed in front of the first element without fully blocking the light flow from the first LED, LEDs with different colors need not be placed side by side. Instead they may be placed in different layers. Thereby the occurrence of colored edges of shadows can be considerably reduced, since a blocking object affects the light flow from LEDs with different colors similarly.

The collimating optical components in the rear layer may comprise compound parabolic concentrators.

The light emitting diodes in the front layer may be arranged on a transparent substrate and may be fed by ITO conductors, which are transparent as well.

In a preferred embodiment, a light emitting diode in the front layer is aligned with a light emitting diode in the rear layer as seen in the lighting direction. The collimating optical component of the light emitting diode in the rear layer may then be arranged to reduce the light flow from the light emitting diode in the rear layer in the area occupied by the light emitting diode in the front layer. This provides good elimination of colored shadows while reducing the loss of light emitted from the rear layer.

As an alternative, the front layer may be offset in relation to a light emitting diode in the rear layer as seen in the lighting direction such that the light flow from the rear layer light emitting diode is small in the area occupied by the light emitting diode in the front layer.

The lighting device may comprise, in addition to the rear and front layers, one or more intermediate layers between the front and rear layers.

These and other aspects of the invention will be apparent from and elucidated with reference to the embodiments described hereinafter.

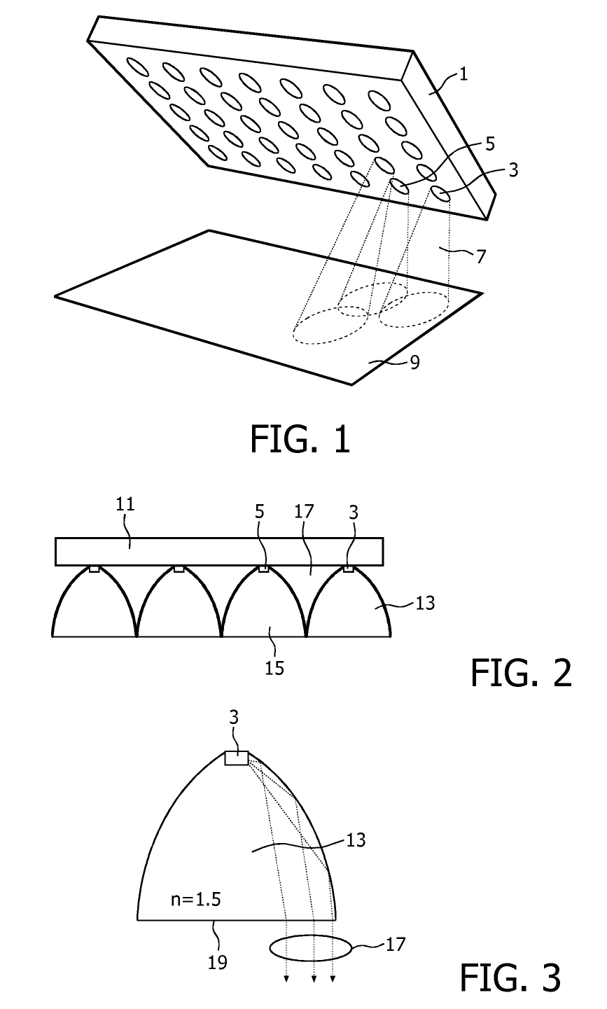

FIG. 1 illustrates schematically the use of a matrix illumination system.

FIG. 2 shows a cross-section through a matrix illumination system.

FIGS. 3-5 illustrate in cross-section different examples of collimating optical components.

FIG. 6 illustrates the occurrence of a color defect in a conventional matrix illumination system.

FIG. 7 illustrates in cross-section a matrix illumination system according to a first embodiment of the invention.

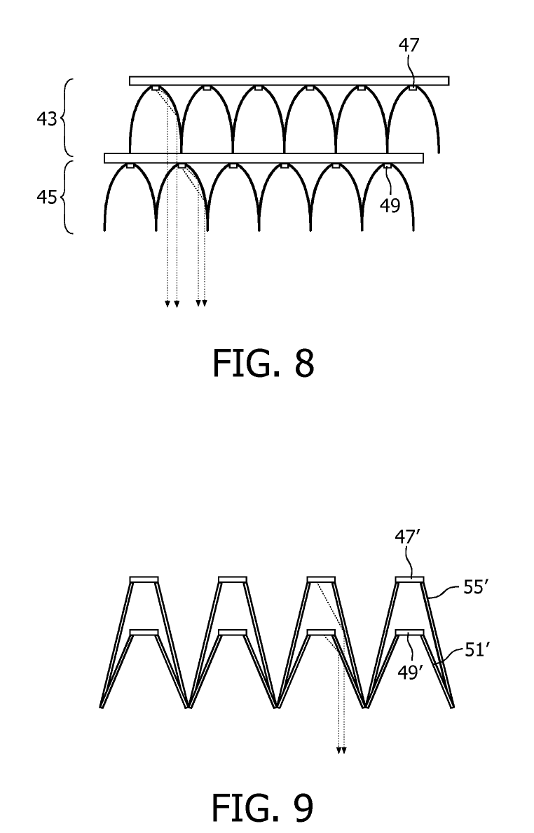

FIG. 8 illustrates in cross-section a matrix illumination system according to a second embodiment of the invention.

FIG. 9 illustrates in cross-section a matrix illumination system according to a third embodiment of the invention.

FIG. 1 illustrates schematically the use of a matrix illumination system. The system comprises a carrier arrangement 1 in the form of a plate with a plurality of light emitting diodes (LEDs) 3, 5, etc., arranged in a pattern on the carrier. The LEDs may, as illustrated in FIG. 1, be arranged in rows and columns, but other configurations are conceivable. The LEDs may e.g. be arranged in columns that are mutually offset, they may be arranged in concentric circles, or they may be arbitrarily or randomly placed on the carrier. As will be illustrated later, each LED may be optically connected to a collimating optical component or element, such that each combination of LED and collimating optical component emits a collimated light beam 7 in a lighting direction. The LEDs on the carrier may be used to illuminate a surface 9, and since each LED may be controlled separately, the illumination may be varied over this surface in many different ways. As will be illustrated LEDs emitting light with different colors may be used, such that the light color is controllable by color mixing.

FIG. 2 shows a cross-section through a matrix illumination system. As mentioned, the system comprises a plurality of LEDs 3, 5, etc. arranged on a preferably planar carrier substrate 11 that may be made of a transparent material, e.g. transparent PMMA (Polymethylmethacrylate). If a transparent substrate is used, the LEDs may preferably be fed by means of transparent conductors (not shown) such as ITO (Indium Tin Oxide) conductors. In the illustrated system, each LED is provided with a collimating optical component 13, 15, etc., which in the illustrated case is a compound parabolic concentrator, in the form of a TIR (Total Internal Reflection) lens.

FIGS. 3-5 illustrate in cross-section different examples of collimating optical components. FIG. 3 illustrates a first example, a compound parabolic concentrator (CPC) (sometimes referred to as a compound parabolic collimator) resembling a parabolic specular reflector. The CPC, however, comprises a solid body of a transparent material with a refractive index higher than air, e.g. 1.5. A major part of the light emitted by the LED in lateral directions is reflected at interface between the CPC body and the surrounding air by total internal reflections (TIR). This light then exits the CPC at the front surface 19 perpendicularly to this surface as a collimated beam 7. Even though the word parabolic usually implies a cross section formed as a cone section, the cross section of a CPC may deviate from this shape to some extent. This component may be preferred in a rear layer as will be described later. In other layers dichroic reflectors are used instead.

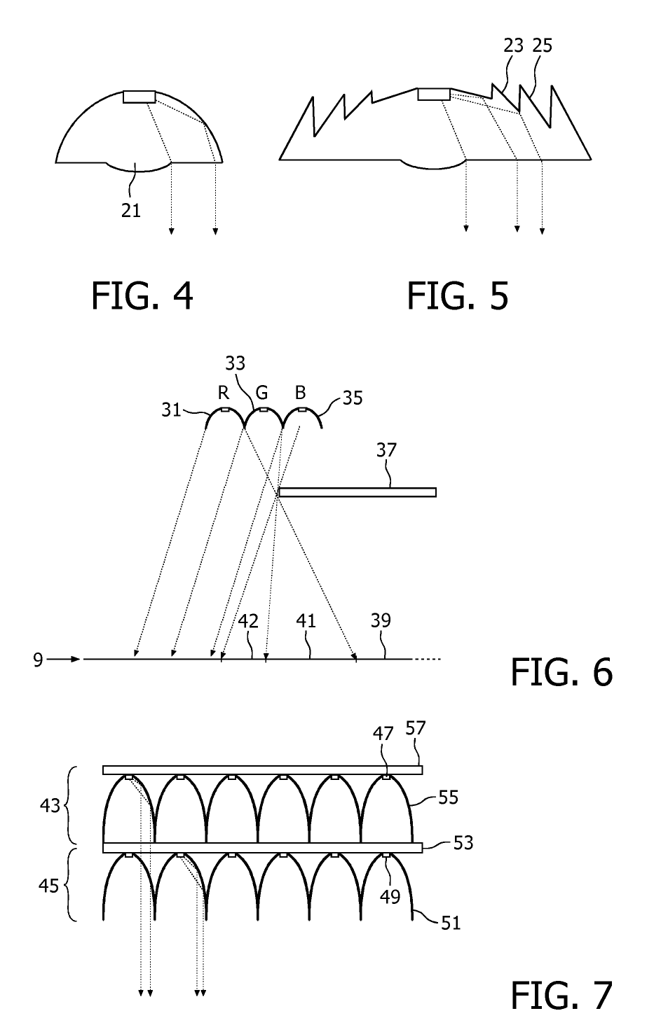

FIG. 4 illustrates a second, somewhat flatter example where an additional lens 21 is integrated in the front surface of the optical element. FIG. 5 illustrates a third example where the collimating optical element in addition to the front surface lens comprises circular, concentric prisms 23, 25, etc. that allow a similar collimating function as in FIG. 4, but with a considerably smaller optical element depth.

FIG. 6 illustrates the occurrence of a color defect in a conventional matrix illumination system. Three LEDs 31, 33, 35 are illustrated as being part of a matrix illumination system comprising a large number of LEDs. The three LEDs emit light with red green and blue color respectively (R, G, B), and by controlling each LEDs current it is possible to illuminate a surface 9 with light having any color, including white light. In the illustrated scenario, there is an obstacle 37 in the light path generating a shadow 39 on the surface 9. Due to the spatial relationship between the diodes, placed side'by side, this shadow will have colored edges. That is, a first area 41, closest to the full shadow 39, will only be illuminated by the first LED 31, and will hence be red. A second area will receive only red and green light from the first and second LEDs 31, 33. In many cases this is a disadvantage with this lighting system, since it is desirable to have the surface 9 illuminated with uniform light as if a light bulb or a fluorescent lamp was used.

FIG. 7 illustrates schematically in cross-section a matrix illumination system according to a first embodiment of the invention. This system uses LEDs with different colors disposed in two layers 43, 45. The LEDs 47 in the rear layer 43 emit light with a first color and the LEDs 49 in the front layer 45 emit light with a second color. In the front layer 45 the collimating optical component 51 of each LED 49 is a dichroic reflector, so that light with the first color, from the LEDs in the rear layer, is transmitted to a great extent and that light with the second color, from the associated LED in the front layer is reflected to a great extent. The result is that the light from the rear LED passes through the front reflector while the front reflector collimates the light from the front LED. The carrier plate 53 of the front layer 45 is transparent, so that light from the rear layer can pass through it essentially unaffected. The LEDs 47 in the rear layer have collimating optical components 55 as well, but these need not have dichroic properties. Instead a regular reflector or a CPC can be used. Neither is there a need for the rear layer carrier plate 57 to be transparent. The collimating optical components in each layer need not be in contact with each other.

The system in FIG. 7 has two layers, but this concept can readily be expanded to three or more layers by the skilled person. Then an intermediate layer with a transparent carrier plate is added where the LEDs have dichroic collimating elements that reflect their light but transmit the light from the LEDs in the rear layer. The collimating optical components of the front layer should transmit the light from both the rear and the intermediate layer.

As illustrated in FIG. 7, the LEDs in the front layer may obstruct the path of the light from the rear layer, since the front and rear LEDs are aligned with each other. The front layer LEDs however only occupies a small fraction of the front layer surface giving only a small loss of light as a shadow. It is also possible to modify the shape of the collimating optical components in the rear layer so that the light flow, from each rear layer LED, in the area of each front layer LED is reduced, thus correspondingly decreasing the loss of light. Instead, the light flow is increased in the areas surrounding each front layer LED.

Another solution to this problem is illustrated in FIG. 8, showing in cross-section a matrix illumination system according to a second embodiment of the invention. Then each light emitting diode in the front layer is offset in relation to the corresponding light emitting diode in the rear layer as seen in the lighting direction. Thus, the light flow from the rear layer light emitting diode is small in the area occupied by the light emitting diode in the front layer.

FIG. 9 illustrates in cross-section a matrix illumination system according to a third embodiment of the invention. Here the reflectors 51′, 55′ of the first and second layers are interconnected to form a unit. Carrier plates are thus not needed in the embodiment and conductors feeding the LEDs are provided on the reflectors. The conductors of the front layer are preferably transparent.

In summary, the invention relates to a lighting system comprising a plurality of LEDs emitting light with different colors. The LEDs are provided with collimating optical components in order to emit collimated light beams. The LEDs are arranged in at least two layers and the collimating optical components in the front layer are dichroic reflectors, so that they reflect the light from the associated front layer LED but transmit the light emitted from the rear layer or layers behind. This eliminates or reduces the occurrence of colored edges around shadows on an illuminated surface.

The invention is not restricted to the embodiments described. It can be altered in different ways within the scope of the appended claims.

1. A lighting device comprising a plurality of light emitting diodes (47, 49), each diode having a collimating optical component (51, 55), and being arranged to emit light in a lighting direction, wherein a first subset of the diodes is placed in a front layer (45), a second subset of the diodes is placed in a rear layer (43), the front layer being placed in front of the rear layer as seen in the lighting direction, and the collimating optical components (51) of the diodes in the front layer comprise dichroic reflectors.

2. A lighting device according to claim 1, wherein the collimating optical components in the rear layer comprise compound parabolic concentrators (CPC).

3. A lighting device according to claim 1, wherein the light emitting diodes in the front layer are arranged on a transparent substrate (53) and are fed by ITO conductors.

4. A lighting device according to claim 1, wherein a light emitting diode (49) in the front layer (45) is aligned with a light emitting diode (47) in the rear layer (43) as seen in the lighting direction.

5. A lighting device according to claim 4, wherein the collimating optical component (55) of the light emitting diode in the rear layer is arranged to reduce the light flow from the light emitting diode (47) in the rear layer in the area occupied by the light emitting diode (49) in the front layer.

6. A lighting device according to claim 1, wherein a light emitting diode in the front layer is offset in relation to a light emitting diode in the rear layer as seen in the lighting direction, so that the light flow from the rear layer light emitting diode is small in the area occupied by the light emitting diode in the front layer.

7. A lighting device according to claim 1, wherein the device, in addition to the front and rear layers, comprises one or more intermediate layers of light emitting diodes, between the front and rear layers.
